(19) United States
(12) Patent Application Publication
(10) Pub. No.: US 2025/0366645 A1
(43) Pub. Date: Dec. 4, 2025

(54) PLUG-IN TYPE DETACHABLE LAYERED CARPET

(71) Applicant: Shaoxing Wuwei New Material Co., Ltd., Shaoxing (CN)

(72) Inventor: Chengjun Huang, Shaoxing (CN)

(21) Appl. No.: 18/778,888

(22) Filed: Jul. 19, 2024

(30) Foreign Application Priority Data
Jun. 4, 2024 (CN) 202410713792.0

(51) Int. Cl. A47G 27/02; A44B 18/00; B32B 7/06

(52) U.S. Cl. CPC A47G 27/025; A44B 18/0057; A44B 18/0065; B32B 7/06; B32B 2250/05; B32B 2471/02

(57) ABSTRACT

The present invention discloses a plug-in type detachable layered carpet, which comprises an upper carpet body and a lower carpet body, wherein the upper carpet body and the lower carpet body are respectively provided with 2-3 layers of fabric, and the upper carpet body and the lower carpet body are arranged one above the other and the adjacent surfaces can be connected in a plug-in manner, so that on the one hand, the top screen layer and the supporting layer respectively belonging to the upper carpet body and the lower carpet body can be quickly disassembled and adjusted in position with low resistance, on the other hand, the upper carpet body can be cleaned by at home independently, and the pattern is less likely to be scratched after washing.

### CROSS-REFERENCE TO RELATED APPLICATIONS

This application claims priority of Chinese Patent Application No. 202410713792.0, filed on Jun. 4, 2024, the entire contents of which are incorporated herein by reference.

### TECHNICAL FIELD

The present invention relates to the technical field of carpets, in particular to the technical field of a double-layer carpet.

### BACKGROUND

Carpet is a floor covering made of natural fibers such as cotton, hemp, wool, silk and grass or chemical synthetic fibers by hand or mechanical process, and it is also one of the arts and crafts categories with a long history and tradition in the world. Carpets can cover the floors of houses, hotels, gymnasiums, exhibition halls, vehicles, ships and airplanes, thus playing the role of noise reduction, heat insulation and decoration.

In the process of carpet processing, surface cloth, the inner core and the base cloth are usually integrally quilted by a quilting machine, bonded by glue or directly thermally compounded in factories, for example a multilayer elastic carpet disclosed in the utility model with an announcement number of CN202723473U, an antibacterial carpet disclosed in the present invention with an announcement number of CN105615584A and a multilayer composite carpet disclosed by the utility model with an announcement number of CN2130065Y. However, this kind of integrated carpet can only be cleaned by special cleaning equipment as a whole (the domestic washing machine cannot hold and clean this kind of integrated carpet because of the small size of the inner cylinder), and there is a problem that the cleaning method is very troublesome. In addition, there are carpets made of a cloth cover and a core in the market. Although this kind of split-type carpet is easy to clean (users can only remove the cover and clean it with a household washing machine), the re-installation of the cover after washing is more troublesome, and the cloth cover and the core are not in good fit (the cloth cover is prone to fold and deformation).

For this reason, some manufacturers choose to lay carpets up and down in layers and use hooks and fluff to bond them. For example, the utility model with an announcement number of CN210144274U discloses a multifunctional pad capable of being disassembled once torn and assembled once adhered. However, the upper layer of this tear-off carpet can not be used alone (the barbs on the bottom surface of the upper layer will be deformed by pressure), and the patterns on the exposed surface may be scratched during cleaning by the household washing machine. In addition, the upper layer and the lower layer of this tear-off carpet stick together as soon as they are placed, which leads to the need for users to tear off and re-adhere the upper layer carpet once it is upturned. This process is not only troublesome to operate, but also very laborious (due to large resistance)

### SUMMARY

The object of the present invention is to solve the problems in the prior art and propose a plug-in type detachable layered carpet, which is very convenient and labor-saving to disassemble and clean.

In order to achieve the above purpose, the present invention provides a plug-in type detachable layered carpet, which includes an upper carpet body and a lower carpet body, wherein the upper carpet body and the lower carpet body are respectively provided with 2-3 layers of fabric, and the upper carpet body and the lower carpet body are arranged one above the other and adjacent surfaces can be connected in a plug-in manner.

Preferably, the upper layer carpet body includes a top screen layer and the lower layer carpet body includes a supporting layer and a cushion layer; the top screen layer, the supporting layer and the cushion layer are arranged in sequence from top to bottom, the supporting layer and the cushion layer are fixed together, and the top screen layer and the supporting layer are connected in a plug-in manner through a female connecting layer and a male connecting layer.

Preferably, a plurality of sockets arranged in a honeycomb shape are provided on the female connecting layer, and the male connecting layer is composed of a base cloth and a plurality of plug posts respectively arranged on the base cloth and capable of being inserted into the corresponding sockets.

Preferably, the top screen layer and the female connecting layer are fixed one above the other and form the upper carpet body together; the sockets are located at a bottom of the female connecting layer; and the male connecting layer, the supporting layer and the cushion layer are fixed in sequence from top to bottom to form the lower carpet body, and the plug posts are located on a top surface of the male connecting layer.

Preferably, the top screen layer and the male connecting layer are fixed one above the other to form the upper carpet body, and the plug posts are located on a bottom surface of the male connecting layer; and the female connecting layer, the supporting layer and the cushion layer are sequentially fixed from top to bottom to form the lower carpet body, and the sockets are located on a top surface of the female connecting layer.

Preferably, the top screen layer and the female connecting layer are fixed one above the other to form the upper carpet body; the female connecting layer, the supporting layer and the cushion layer are fixed from top to bottom to form the lower carpet body; and the sockets are respectively arranged on the bottom surface of the upper female connecting layer and the top surface of the lower female connecting layer; the male connecting layer is arranged between the upper carpet body and the lower carpet body and independently forms a middle carpet body; and the plug posts are arranged on the top surface and the bottom surface of the male connecting layer.

Preferably, the plug post includes a post body and an elastic baffle, one end of the post body is fixed on the base cloth and the other end expands outwards to form a ball part; a middle part of the elastic baffle is wrapped outside the ball part, and an edge of the elastic baffle is upturned outwards to enclose with the ball part to form an annular gap; and an inner wall of the socket is provided with an annular convex edge which can abut against the upturned edge of the elastic baffle. Preferably, the elastic baffle is composed of a rubber sheet and a substrate buried in the rubber sheet. Preferably, the edge of the elastic baffle is evenly provided with a plurality of notches. The present invention has the beneficial effects that:
1) the upper carpet body and the lower carpet body, which are respectively composed of 2-3 layers of fabric, are connected in a plug-in manner, so that the upper carpet body and the lower carpet body can be connected as a whole for common use, and also the upper carpet body and the lower carpet body can be used separately;
2) by arranging the female connecting layer with a plurality of sockets arranged in a honeycomb shape and the male connecting layer with plug post which can be plugged one-to-one with each socket between the top screen layer and the supporting layer, on the one hand, the top screen layer and the supporting layer respectively belonging to the upper carpet body and the lower carpet body can be disassembled and positioned quickly with low resistance, and on the other hand, the upper carpet body can be cleaned independently at home and the pattern is less likely to be scratched after washing;
3) by arranging the supporting layer and the cushion layer in the lower carpet body respectively, the treading comfort of the carpet can be improved by using the supporting layer, and the skid resistance of the carpet can be improved by using the cushion layer;
4) by wrapping the ball part of the post body with an elastic baffle with an outward edge and a notch to form the plug post, and additionally arranging an annular convex edge on the inner wall of the socket, the alignment adjustment between the upper carpet body and the lower carpet body is not affected, and after each group of plug post and socket are connected by insertion, each plug post can be effectively prevented from actively and reversely withdrawing out of the corresponding socket in advance.

The features and advantages of the present invention will be described in detail by examples with reference to the accompanying drawings.

### BRIEF DESCRIPTION OF DRAWINGS

FIG. 1 is a front view of Embodiment 1 when the upper carpet body is separated from the lower carpet body;

FIG. 2 is a bottom view of the mother contact layer of Embodiment 1;

FIG. 3 is a front view of the male connecting layer of Embodiment 1;

FIG. 4 is a front view of Embodiment 2 when the upper carpet body is separated from the lower carpet body;

FIG. 5 is a front view of Embodiment 3 when the upper carpet body, the middle carpet and the lower carpet body are separated;

FIG. 6 is a front view of the male connecting layer of Embodiment 3;

FIG. 7 is a front view of the plug post of Embodiment 4;

FIG. 8 is a cross-sectional view of the plug post of Embodiment 4;

FIG. 9 is a schematic diagram of the insertion of the socket and the plug post in Embodiment 4;

In the figures: 1—Top screen layer, 2—Female connecting layer, 21—Socket, 22—Annular convex edge, 3—Male connecting layer, 31—Base cloth, 32—Plug post, 321—Post body, 322—Elastic baffle, 3221—Rubber sheet, 3222—Substrate and 3223-3223—Notch, 323—Annular gap, 4—Supporting layer, 5—Cushion layer.

### DESCRIPTION OF EMBODIMENTS

### Embodiment 1

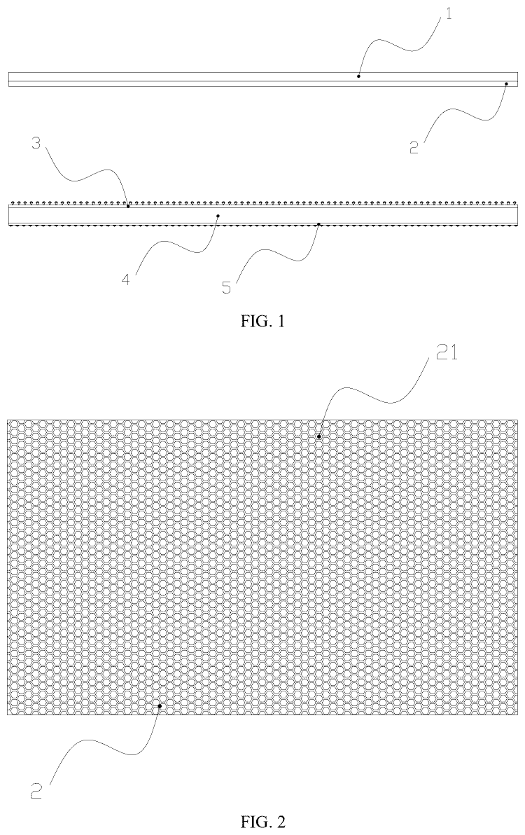

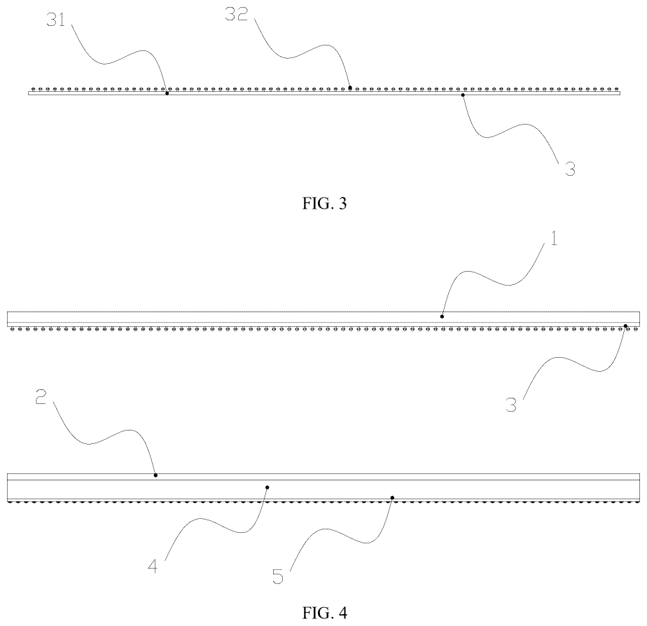

Referring to FIG. 1, FIG. 2 and FIG. 3, the plug-in type detachable layered carpet of the present invention comprises an upper carpet body and a lower carpet body, wherein the upper carpet body and the lower carpet body are respectively provided with 2-3 layers of fabric, and the upper carpet body and the lower carpet body are arranged one above the other and their adjacent surfaces are connected in a plug-in manner.

The upper carpet body comprises a top screen layer 1, and the lower carpet body comprises a supporting layer 4 and a cushion layer 5; the top screen layer 1, the supporting layer 4 and the cushion layer 5 are sequentially arranged from top to bottom; the supporting layer 4 and the cushion layer 5 are fixed together, and the top screen layer 1, the supporting layer 4 and the cushion layer 5 are connected in a plug-in manner through a female connecting layer 2 and a male connecting layer 3; wherein, the top screen layer 1, the supporting layer 4 and the cushion layer 5 can be made of fabrics or nonwovens made of fibers (such as cotton, hemp, wool, silk, polyester, nylon or polypropylene) or directly made of plastics (such as TPR, TPE or TPU). The bottom surface of the cushion layer 5 is provided with anti-slip texture formed by drip molding, thereby improving the friction between the carpet and the ground and effectively avoiding the free sliding of the carpet; the top surfaces of the top screen layer 1 and the male connecting layer 3 can also be printed with patterns respectively to improve the aesthetics of the carpet.

The female connecting layer 2 is provided with a plurality of sockets 21 arranged in a honeycomb shape, and the male connecting layer 3 is composed of a base cloth 31 and a plurality of plug post 32 respectively arranged on the base cloth 31 and inserted into the corresponding sockets 21.

The top screen layer 1 and the female connecting layer 2 are fixed one above the other and form the upper carpet body together, the sockets 21 are located at the bottom of the female connecting layer 2; the male connecting layer 3, the supporting layer 4 and the cushion layer 5 are fixed in turn from top to bottom and form the lower carpet body together, and the plug posts 32 are located at the top surface of the male connecting layer 3.

When in use, the upper carpet body is first placed on the top surface of the lower carpet body, and then after the upper carpet body is aligned with the lower carpet body, the upper carpet body is pressed down until each socket 21 and plug post 32 are connected by insertion one by one. In addition, the upper carpet body and the lower carpet body can also be used separately. When the lower carpet body is used alone, the plug post 32 on the top surface of the male layer 3 can also massage the soles of the feet to some extent.

After a period of use, if a large piece of dirt appears on the top screen layer 1, the user can directly remove the upper carpet body from the lower carpet body and use a household washing machine to clean it. Due to the large volume and heavy weight of the lower carpet body, it is suggested to send it to a special cleaning institution for cleaning regularly or use a household fabric cleaning machine for cleaning.

### Embodiment 2

Referring to FIG. 4, the top screen layer 1 and the male connecting layer 3 are fixed one above the other to form an upper carpet body, the plug posts 32 are located on the bottom surface of the male connecting layer 3; the female connecting layer 2, the supporting layer 4 and the cushion layer 5 are fixed from top to bottom to form the lower carpet body, and the sockets 21 are located on the top surface of the female connecting layer 2.

Others are the same as in Embodiment 1.

### Embodiment 3

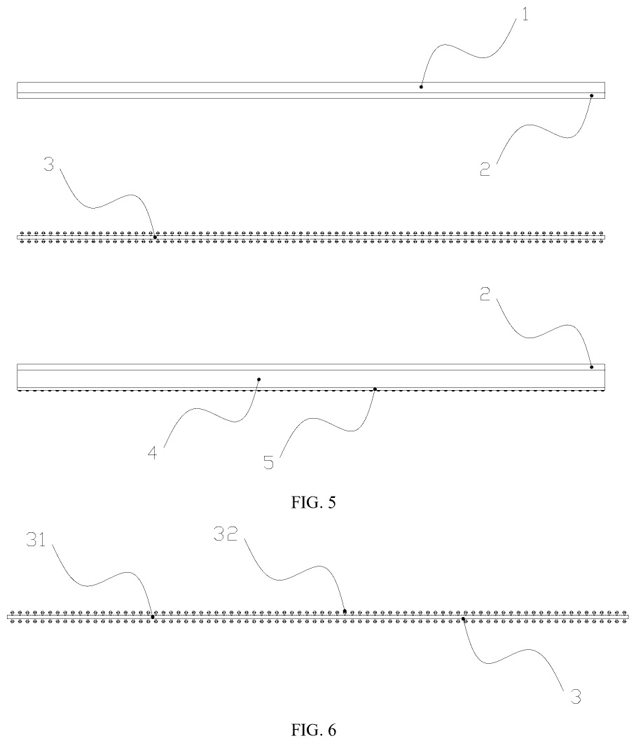

Referring to FIGS. 5 and 6, the Top screen layer 1 and the female connecting layer 2 are fixed one above the other to form an upper carpet body, the female connecting layer 2, the supporting layer 4 and the cushion layer 5 are fixed from top to bottom to form a lower carpet body; the sockets 21 are respectively arranged on the bottom surface of the upper female connecting layer 2 and the top surface of the lower female connecting layer 2; the male connecting layer 3 is arranged between the upper carpet body and the lower carpet body and constitute the middle carpet body alone, and the plug posts 32 are located on the top and bottom surfaces of the male connecting layer 3.

Others are the same as in Embodiment 1.

In this embodiment, the upper carpet body and the lower carpet body are indirectly connected through the middle carpet. With this design, after use, the user can first take off the middle carpet separately, so that on the one hand, the upper carpet body is sent to the household washing machine for cleaning, and on the other hand, the lower carpet body is sent to a special cleaning mechanism for cleaning at regular intervals or cleaned by the household fabric cleaning machine. Compared with the Embodiment 1, the lower carpet body is easier to be cleaned because it does not have the male connecting layer 3 (that is, this embodiment can avoid the male connecting layer 3 from being cleaned with other layers).

### Embodiment 4

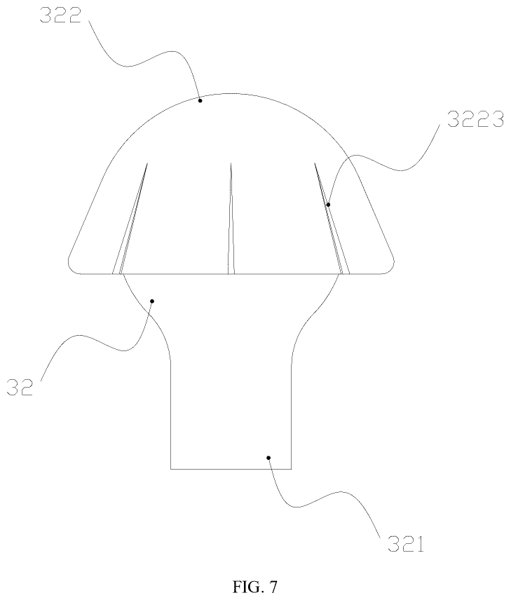

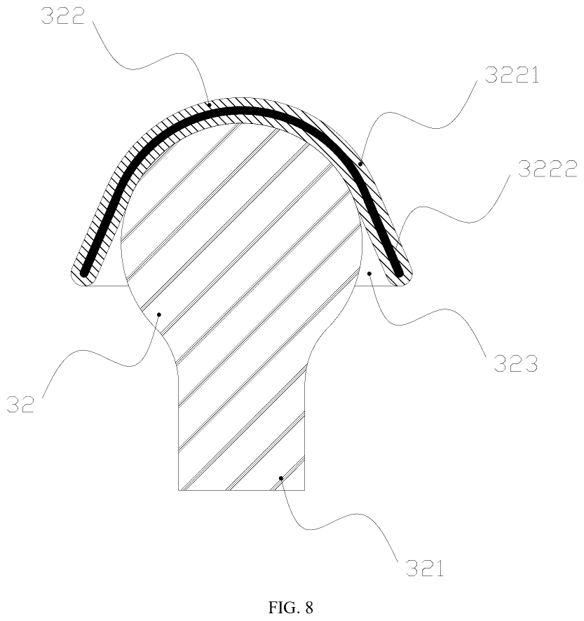

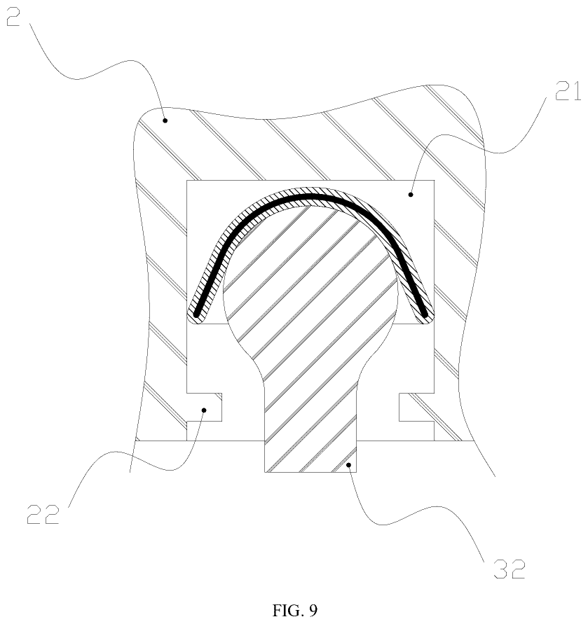

Referring to FIG. 7, FIG. 8 and FIG. 9, the plug post 32 includes a post body 321 and an elastic baffle 322. One end of the post body 321 is fixed on the base cloth 31, while the other end expands outwards to form a ball part. The middle part of the elastic baffle 322 is wrapped outside the ball part, and the edge of the elastic baffle 322 is upturned outwards to enclose with the ball part to form an annular gap 323. The inner wall of the socket 21 is provided with an annular convex edge 22 which can abut against the upturned edge of the elastic baffle 322.

The elastic baffle 322 is composed of a rubber sheet 3221 and a substrate 3222 buried in the rubber sheet 3221.

A plurality of notches 3223 are uniformly arranged on the edge of the elastic baffle 322.

Others are the same as in Embodiment 1.

Compared with the first embodiment, the insertion fastness between the upper carpet body and the lower carpet body in this embodiment is higher.

The above embodiment is an illustration of the present invention, not a limitation of the present invention, and any solution after simple transformation of the present invention belongs to the protection scope of the present invention.

The present invention discloses a plug-in type detachable layered carpet, which comprises an upper carpet body and a lower carpet body, wherein the upper carpet body and the lower carpet body are respectively provided with 2-3 layers of fabric, and the upper carpet body and the lower carpet body are arranged one above the other and the adjacent surfaces can be connected in a plug-in manner, so that on the one hand, the top screen layer and the supporting layer respectively belonging to the upper carpet body and the lower carpet body can be quickly disassembled and adjusted in position with low resistance, on the other hand, the upper carpet body can be cleaned by at home independently, and the pattern is less likely to be scratched after washing.

1. A plug-in type detachable layered carpet, comprising an upper carpet body and a lower carpet body, wherein the upper carpet body and the lower carpet body are respectively provided with 2-3 layers of fabric, and the upper carpet body and the lower carpet body are arranged one above the other and adjacent surfaces can be connected in a plug-in manner.

2. The plug-in type detachable layered carpet according to claim 1, wherein the upper layer carpet body comprises a top screen layer (1), and the lower layer carpet body comprises a supporting layer (4) and a cushion layer (5); the top screen layer (1), the supporting layer (4) and the cushion layer (5) are arranged in sequence from top to bottom, the supporting layer (4) and the cushion layer (5) are fixed together, and the top screen layer (1) and the supporting layer (4) are connected in a plug-in manner through a female connecting layer (2) and a male connecting layer (3).

3. The plug-in type detachable layered carpet according to claim 2, wherein a plurality of sockets (21) arranged in a honeycomb shape are provided on the female connecting layer (2), and the male connecting layer (3) is composed of a base cloth (31) and a plurality of plug posts (32) respectively arranged on the base cloth (31) and capable of being inserted into the corresponding sockets (21).

4. The plug-in type detachable layered carpet according to claim 3, wherein the top screen layer (1) and the female connecting layer (2) are fixed one above the other and form the upper carpet body together; the sockets (21) are located at a bottom of the female connecting layer (2);
and the male connecting layer (3), the supporting layer (4) and the cushion layer (5) are fixed in sequence from top to bottom to form the lower carpet body, and the plug posts (32) are located on a top surface of the male connecting layer (3).

5. The plug-in type detachable layered carpet according to claim 3, wherein the top screen layer (1) and the male connecting layer (3) are fixed one above the other to form the upper carpet body, and the plug posts (32) are located on a bottom surface of the male connecting layer (3); and the female connecting layer (2), the supporting layer (4) and the cushion layer (5) are sequentially fixed from top to bottom to form the lower carpet body, and the sockets (21) are located on a top surface of the female connecting layer (2).

6. The plug-in type detachable layered carpet according to claim 3, wherein the top screen layer (1) and the female connecting layer (2) are fixed one above the other to form the upper carpet body; the female connecting layer (2), the supporting layer (4) and the cushion layer (5) are fixed from top to bottom to form the lower carpet body; and the sockets (21) are respectively arranged on the bottom surface of the upper female connecting layer (2) and the top surface of the lower female connecting layer (2); the male connecting layer (3) is arranged between the upper carpet body and the lower carpet body and independently forms a middle carpet body; and the plug posts (32) are arranged on the top surface and the bottom surface of the male connecting layer (3).

7. The plug-in type detachable layered carpet according to claim 3, wherein the plug post (32) comprises a post body (321) and an elastic baffle (322), one end of the post body (321) is fixed on the base cloth (31) and the other end expands outwards to form a ball part; a middle part of the elastic baffle (322) is wrapped outside the ball part, and an edge of the elastic baffle (322) is upturned outwards to enclose with the ball part to form an annular gap (323); and an inner wall of the socket (21) is provided with an annular convex edge (22) which can abut against the upturned edge of the elastic baffle (322).

8. The plug-in type detachable layered carpet according to claim 4, wherein the plug post (32) comprises a post body (321) and an elastic baffle (322), one end of the post body (321) is fixed on the base cloth (31) and the other end expands outwards to form a ball part; a middle part of the elastic baffle (322) is wrapped outside the ball part, and an edge of the elastic baffle (322) is upturned outwards to enclose with the ball part to form an annular gap (323); and an inner wall of the socket (21) is provided with an annular convex edge (22) which can abut against the upturned edge of the elastic baffle (322).

9. The plug-in type detachable layered carpet according to claim 5, wherein the plug post (32) comprises a post body (321) and an elastic baffle (322), one end of the post body (321) is fixed on the base cloth (31) and the other end expands outwards to form a ball part; a middle part of the elastic baffle (322) is wrapped outside the ball part, and an edge of the elastic baffle (322) is upturned outwards to enclose with the ball part to form an annular gap (323); and an inner wall of the socket (21) is provided with an annular convex edge (22) which can abut against the upturned edge of the elastic baffle (322).

10. The plug-in type detachable layered carpet according to claim 6, wherein the plug post (32) comprises a post body (321) and an elastic baffle (322), one end of the post body (321) is fixed on the base cloth (31) and the other end expands outwards to form a ball part; a middle part of the elastic baffle (322) is wrapped outside the ball part, and an edge of the elastic baffle (322) is upturned outwards to enclose with the ball part to form an annular gap (323); and an inner wall of the socket (21) is provided with an annular convex edge (22) which can abut against the upturned edge of the elastic baffle (322).

11. The plug-in type detachable layered carpet according to claim 7, wherein the elastic baffle (322) is composed of a rubber sheet (3221) and a substrate (3222) buried in the rubber sheet (3221).

12. The plug-in type detachable layered carpet according to claim 8, wherein the elastic baffle (322) is composed of a rubber sheet (3221) and a substrate (3222) buried in the rubber sheet (3221).

13. The plug-in type detachable layered carpet according to claim 9, wherein the elastic baffle (322) is composed of a rubber sheet (3221) and a substrate (3222) buried in the rubber sheet (3221).

14. The plug-in type detachable layered carpet according to claim 10, wherein the elastic baffle (322) is composed of a rubber sheet (3221) and a substrate (3222) buried in the rubber sheet (3221).

15. The plug-in type detachable layered carpet according to claim 11, wherein the edge of the elastic baffle (322) is evenly provided with a plurality of notches (3223).

16. The plug-in type detachable layered carpet according to claim 12, wherein the edge of the elastic baffle (322) is evenly provided with a plurality of notches (3223).

17. The plug-in type detachable layered carpet according to claim 13, wherein the edge of the elastic baffle (322) is evenly provided with a plurality of notches (3223).

18. The plug-in type detachable layered carpet according to claim 14, wherein the edge of the elastic baffle (322) is evenly provided with a plurality of notches (3223).
